(19) United States
(12) Patent Application Publication
(10) Pub. No.: US 2022/0315108 A1
(43) Pub. Date: Oct. 6, 2022

(54) SUBFRAME

(71) Applicant: HONDA MOTOR CO., LTD., Tokyo (JP)

(72) Inventor: Shosuke Ohhama, Wako-shi (JP)

(21) Appl. No.: 17/680,399

(22) Filed: Feb. 25, 2022

(30) Foreign Application Priority Data
Mar. 31, 2021 (JP) 2021-062189

(51) Int. Cl. B62D 21/11; B62D 21/02; B60G 7/00; B60G 7/02

(52) U.S. Cl. CPC B62D 21/11; B62D 21/02; B60G 7/001; B60G 7/02

(57) ABSTRACT

A subframe according to an embodiment is a subframe that holds a suspension device and includes: a pair of side members extending in a front-back direction; a first cross member coupling the side members to connect the side members in a vehicle width direction; a second cross member disposed away from and behind the first cross member and coupling the side members to connect the side members in the vehicle width direction; a first vehicle body attachment point disposed further backward than the first cross member and formed to extend outward in the vehicle width direction from the side member; and a second vehicle body attachment point disposed further backward than the first vehicle body attachment point and formed to extend outward in the vehicle width direction from the side member, and a suspension arm extending from the suspension device is attached to the side member.

### CROSS-REFERENCE TO RELATED APPLICATION

Priority is claimed on Japanese Patent Application No. 2021-062189, filed on Mar. 31, 2021, the contents of which are incorporated herein by reference.

### BACKGROUND

### Field of the Invention

The present invention relates to a subframe.

### Background

In the related art, Japanese Unexamined Patent Application, First Publication No. 2002-337725 discloses a hollow member as a member constituting a subframe (suspension member) used in a vehicle such as an automobile. The hollow member disclosed in Japanese Unexamined Patent Application, First Publication No. 2002-337725 is a side member of a suspension member for a vehicle including a main body with a hollow shape and a welding bolt, which is attached to a lower wall of the main body, to which another member is screw-bonded, and including no seam in a circumferential direction of the main body, a bolt is attached on an inner surface side of the main body by forming a hole in an upper wall of the main body and inserting the bolt into the hole, and the hole is located on an axial line of the bolt secured to the inner surface and has a size with which it surrounds the bolt when seen in an axial direction to enable the bolt and an electrode rod to weld-secure the bolt into the inner surface to be inserted into the main body.

Also, it describes that it is possible to obtain advantages that, according to the aforementioned hollow member, it is not necessary to join the bracket for attaching the bolt to an outer circumferential wall of the main body through welding or the like, and as a result, it is possible to reduce the weight and manufacturing cost corresponding to the bracket and to improve a degree of freedom in layout since there is no need to consider interference between the bracket and other components.

In a typical subframe 100A as illustrated in FIG. 1, such as the subframe (suspension member) for a vehicle using the hollow member according to the disclosure in Japanese Unexamined Patent Application, First Publication No. 2002-337725, which is a representative example, vehicle attachment points 104A and 105A are disposed at locations in both sides in a vehicle width direction at positions with cross members 102A and 103A on a side member 101A sandwiched therebetween.

### SUMMARY

However, even if a hollow member is employed for a subframe, it is difficult to shorten the length of the side member in a vehicle front-back direction according to the aforementioned disposition of the vehicle attachment points, which limits weight reduction.

Additionally, although shortening of the attachment span of the vehicle attachment points (the distance between the vehicle attachment points disposed at the two locations on one side in the vehicle width direction) has been exemplified as a measure for weight reduction, there is concern of this causing degradation of rigidity of the subframe.

An object of an aspect of the invention is to provide a subframe with sufficient rigidity to withstand a load input from a suspension arm while its weight is reduced by shortening an attachment span between vehicle attachment points.

A subframe according to a first aspect of the invention is a subframe that holds a suspension device including: a pair of side members extending in a front-back direction; a first cross member coupling the side members to connect the side members in a vehicle width direction; a second cross member disposed away from and behind the first cross member and coupling the side members to connect the side members in the vehicle width direction; a first vehicle body attachment point disposed further backward than the first cross member and formed to extend outward in the vehicle width direction from the side member; and a second vehicle body attachment point disposed further backward than the first vehicle body attachment point and formed to extend outward in the vehicle width direction from the side member, and in which a suspension arm extending from the suspension device is attached to the side member.

With the aforementioned configuration, the first vehicle body attachment point is disposed further backward than the first cross member and is formed to extend outward in the vehicle width direction from the side member. Also, the second vehicle body attachment point is disposed further backward than the first vehicle body attachment point and is formed to extend outward in the vehicle width direction from the side member. In this manner, the distance between the first vehicle attachment point and the second vehicle attachment point is shortened, and it is possible to obtain compact side member, which contributes to weight reduction and enables reduction of manufacturing cost.

Moreover, each of the first vehicle body attachment point and the second vehicle body attachment point is formed to extend outward in the vehicle width direction. Therefore, even if the distance between the first vehicle body attachment point and the second vehicle body attachment point is shortened, it is possible to maintain rigidity against a load in directions including components in the front-back direction and the vehicle width direction input from the suspension arms to the subframe without any loss.

In a subframe according to a second aspect of the invention, the suspension arm may be disposed to be aligned on a straight line on which the first cross member extends in a top view.

With the aforementioned configuration, the suspension arm is disposed to be aligned in the vicinity of the straight line on which the cross member extends. Therefore, it is possible to receive a load in directions including components in the front-back direction and the vehicle width direction input from the suspension arm by a part with high rigidity.

A subframe according to a third aspect of the invention may include a suspension arm bracket for attaching the suspension arm to the side member, the side member may include an extended portion extending further forward than the first cross member, and the suspension arm bracket may be joined to a part of the side member including the extended portion.

With the aforementioned configuration, the side member includes the extended portion extending further forward than the first cross member. Also, the suspension arm bracket is joined to the part of the side member including the extended portion. Therefore, attachment rigidity of the suspension arm bracket and the side member is improved.

In a subframe according to a fourth aspect of the invention, the extended portion may extend in a direction including an outward direction component in the vehicle width direction, the extended portion may include a second end portion directed backward and extending in an up-down direction, and the suspension arm bracket may be joined to the second end portion.

With the aforementioned configuration, the extended portion extends in the direction including the outward direction component in the vehicle width direction, and the extended portion includes the second end portion directed backward and extending in the up-down direction. Also, the suspension arm bracket is joined to the second end portion of the extended portion. Therefore, it is possible to efficiently disperse a load including a component in the front-back direction input from the suspension arm to the extended portion through the suspension arm bracket, and attachment rigidity of the suspension arm and the suspension arm bracket to the subframe is thus improved as compared with a case in which the suspension arm bracket is joined only to a body portion.

In a subframe according to a fifth aspect of the invention, the extended portion may include a front end portion formed into a curved surface shape.

With the aforementioned configuration, the extended portion includes the front end portion formed into the curved surface shape. Therefore, even if an automobile having the subframe according to the aforementioned configuration mounted therein is in a collision due to a traffic accident or the like and physical contact between the extended portion and peripheral portions occurs, for example, it is possible to reduce the degree of breakage of the peripheral components.

According to an aspect of the invention, it is possible to provide a subframe including sufficient rigidity to withstand a load input from the suspension arm while its weight is reduced by shortening the attachment span between the vehicle attachment points.

### BRIEF DESCRIPTION OF THE DRAWINGS

FIG. 1 is a plan view of a subframe according to the related art.

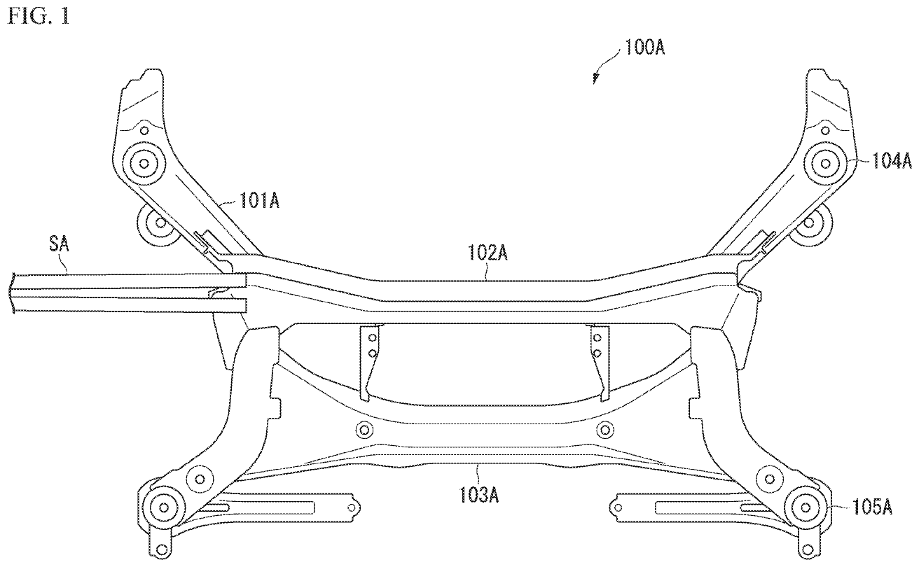

FIG. 2 is a plan view of a subframe according to an embodiment of the invention.

FIG. 3 is a perspective view of the subframe according to the embodiment of the invention.

FIG. 4 is an enlarged view of a part surrounded by the dotted line in FIG. 3.

FIG. 5 is an enlarged perspective view in the vicinity of a suspension arm bracket of the subframe according to the embodiment of the invention.

FIG. 6 is an enlarged plan view in the vicinity of the suspension arm bracket of the subframe according to the embodiment of the invention.

### DESCRIPTION OF EMBODIMENTS

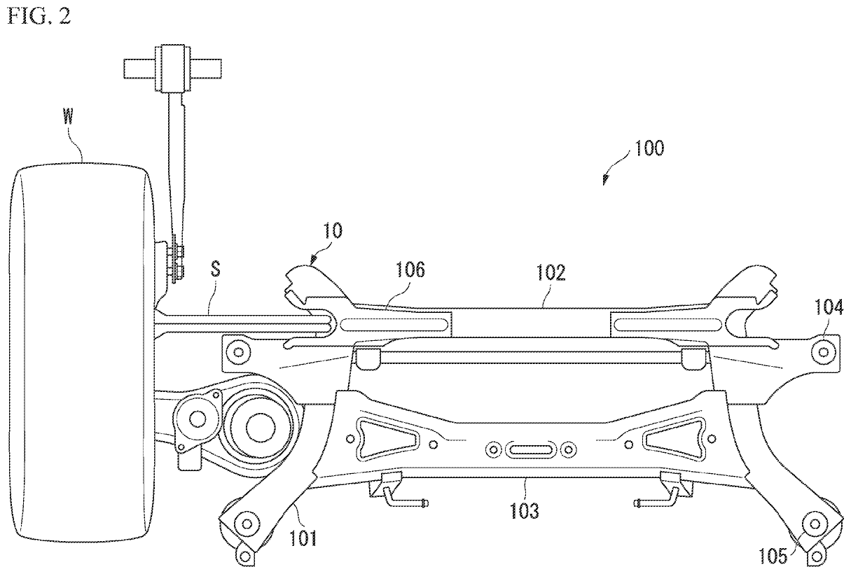

Hereinafter, a subframe according to an embodiment of the invention will be described with reference to FIGS. 2 to 6.

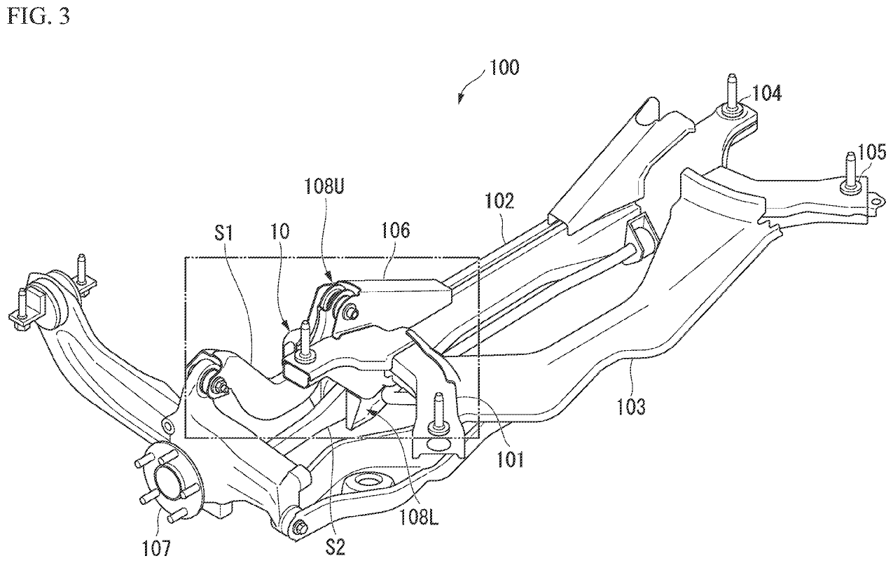

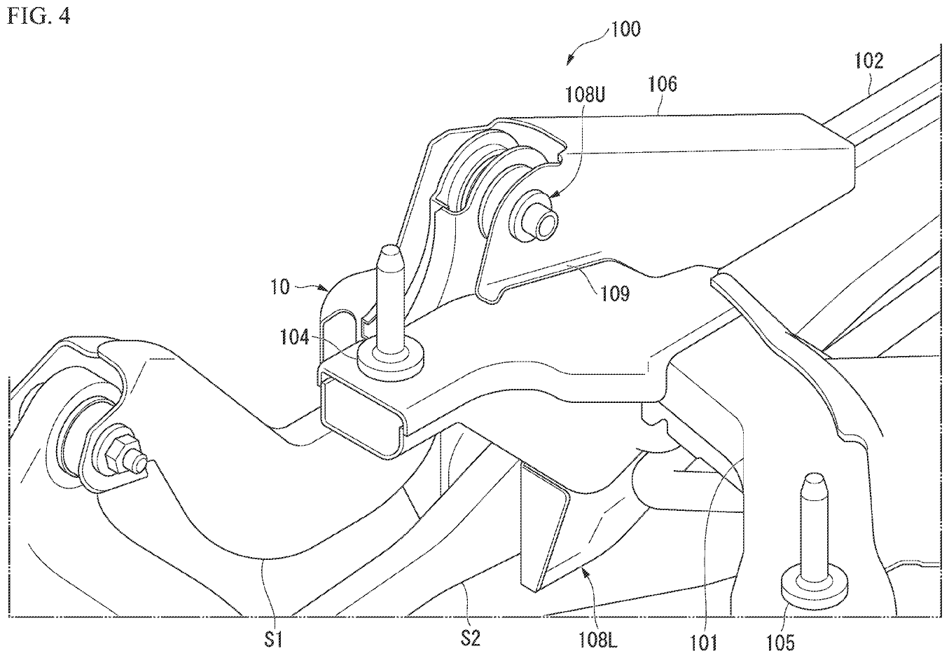

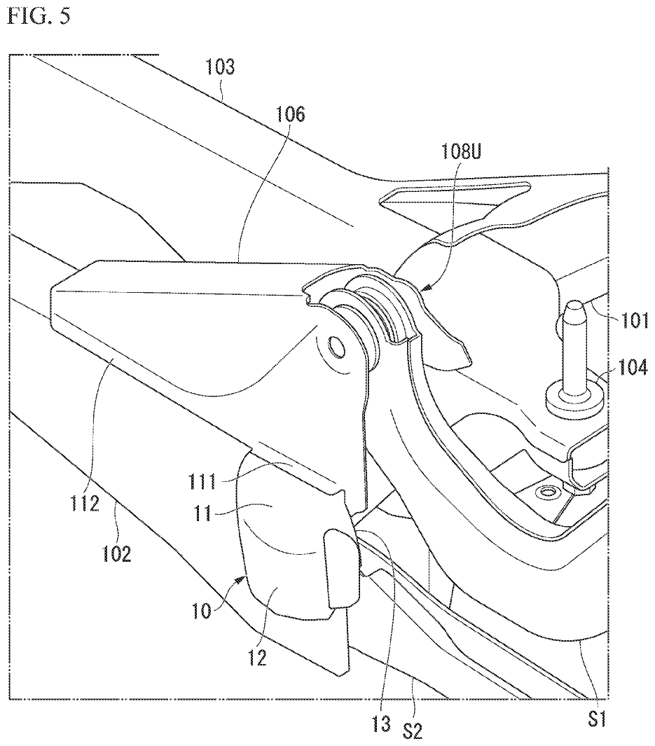

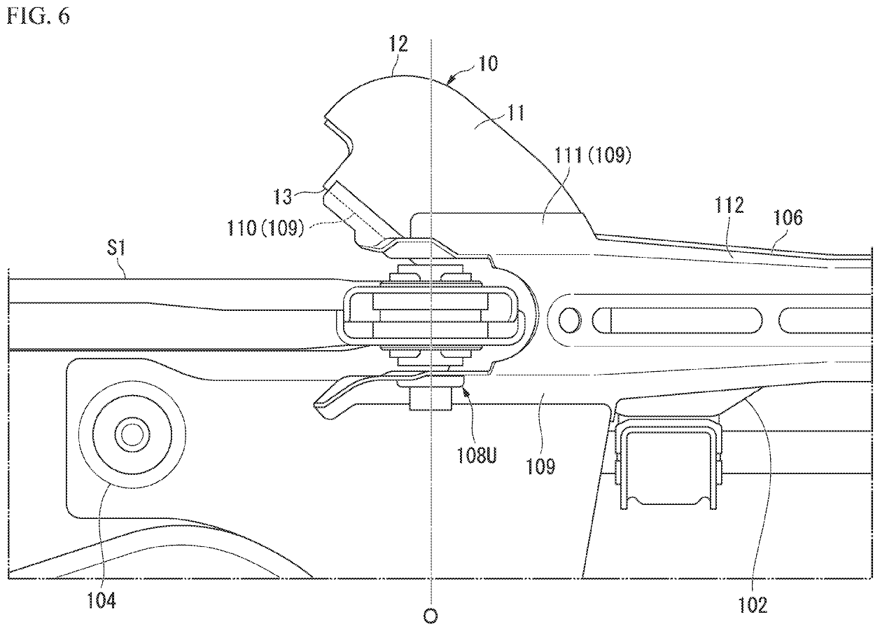

FIG. 2 is a plan view of a subframe 100 according to an embodiment of the invention. FIG. 3 is a perspective view of the subframe 100 according to the embodiment of the invention. FIG. 4 is an enlarged perspective view in the vicinity of vehicle body attachment points of the subframe 100 according to the embodiment of the invention. FIG. 5 is an enlarged perspective view in the vicinity of suspension arm bracket 106 of the subframe 100 according to the embodiment of the invention. FIG. 6 is an enlarged plan view in the vicinity of the suspension arm bracket 106 of the subframe 100 according to the embodiment of the invention.

Note that since the subframe 100 is horizontally symmetrical, the left side of the subframe 100 according to the embodiment will be mainly described herein. Also, the configuration and disposition of the subframe 100 on the left side are assumed to be also the configuration and the disposition of the subframe 100 on the right side unless particularly indicated otherwise in the description.

### Definition of Directions

In description of the subframe 100 according to the present embodiment, a front direction and a front side mean a vehicle front direction when the subframe 100 is attached to a vehicle, and a rear direction and a rear side mean a vehicle rear direction when the subframe 100 is attached to the vehicle. A vehicle width direction means a left-right direction corresponding to the front direction and the front side and the rear direction and the rear side. Also, a vertical direction means a direction in which the subframe 100 corresponds to the vertical direction when the subframe 100 is attached to the vehicle and is disposed on a substantially horizontal road or the like and influences of a weight balance and the like are not taken into consideration.

As illustrated in FIG. 2, the subframe 100 according to the present embodiment includes a pair of side members 101, a first cross member 102, a second cross member 103, first vehicle body attachment points 104, and second vehicle body attachment points 105.

A suspension arms S are attached to the side members 101 with suspension arm brackets 106. Each suspension arm S is constituted by an upper arm S1 and a control arm S2.

The side members 101 are members made of metal and extending in the front-back direction and is formed through press molding or the like. As the metal constituting the side members 101, an aluminum alloy, for example, is used. The pair of side members 101 are disposed at positions away from each other in the vehicle width direction and are coupled to be connected to each other in the vehicle width direction by the first cross member 102 and the second cross member 103 disposed away from and behind the first cross member 102. As illustrated in FIG. 3, the side members 101 are coupled to an axle 107 via the upper arm S1 and the control arm S2.

The first vehicle body attachment points 104 are formed to extend outward in the vehicle width direction from the side members 101 at positions outside the side members 101 in the vehicle width direction and positions behind the first cross member 102. Also, the second vehicle body attachment points 105 are formed to extend outward in the vehicle width direction from the side members 101 at positions behind the first vehicle body attachment points 104. Both the first vehicle body attachment points 104 and the second vehicle body attachment points 105 are disposed behind the suspension arms S.

It is possible to maintain rigidity against a load in directions including components of the front-back direction and the vehicle width direction input from the suspension arm S to the subframe 100 without any loss, even if the distance between the first vehicle body attachment points 104 and the second vehicle body attachment points 105 in the front-back direction is shortened, by forming the first vehicle body attachment points 104 and the second vehicle body attachment points 105 at the aforementioned positions.

The first cross member 102 is a member made of metal and extending in the vehicle width direction and is formed through press molding or the like. As the metal constituting the first cross member 102, an aluminum alloy, for example, is used. The first cross member 102 is coupled to connect the pair of side members 101 in the vehicle width direction.

The second cross member 103 is a member made of metal and extending in the vehicle width direction and is formed through press molding or the like, similarly to the first cross member 102. As the metal constituting the second cross member 103, an aluminum alloy, for example, is used similarly to the first cross member 102.

The second cross member 103 is disposed away from and behind the first cross member 102 and is coupled to connect the side members 101 in the vehicle width direction.

Extended portions 10 are parts of the side members 101 formed to extend further forward than the first cross member 102 as illustrated in FIGS. 4 to 6. Each extended portion 10 includes a body portion 11, a first end portion 12, and a second end portion 13. Also, the extended portions 10 are formed to extend toward the directions including components on the outer sides in the vehicle width direction. In this manner, each extended portion 10 has a shape in which the first end portion 12 is located further forward than the second end portion 13 and the second end portion 13 is located further backward than the first end portion 12. A suspension arm bracket 106, which will be described later, is disposed at and attached to the body portion 11 and the second end portion 13.

The body portion 11 is a surface of the extended portion 10 facing upward in the vertical direction. The first end portion 12 is a front end portion of the extended portion 10. The second end portion 13 is a surface of the extended portion 10 facing backward and extending in the up-down direction.

Note that the body portion 11 may be an inclined surface joined to the second end portion 13 (a rear surface of the extended portion 10) and extending upward toward the front side.

Also, the first end portion 12 (front end portion) may be formed into a curved surface shape.

The upper arm S1 constitutes one of the suspension arms S as illustrated in FIGS. 3 to 6. Additionally, the upper arm S1 is disposed above the suspension arm S in the vertical direction and on a straight line on which the first cross member 102 extends in a top view.

Holes are formed at the upper arm S1 on the left side and the right side of the upper arm S1.

The upper arm S1 is coupled to the axle 107 by a shaft being inserted into both the hole formed on the left side of the upper arm S1 and the hole formed in the axle 107 and by a locking member, which is not illustrated, locking the shaft such that the shaft cannot fall out. Moreover, the upper arm S1 is coupled to each side member 101 at an upper coupling portion 108U. At the upper coupling portion 108U, a shaft is inserted into both the hole formed on the right side of the upper arm S1 and the hole formed in the suspension arm bracket 106 and the shaft is locked by a locking member, which is not illustrated. In this manner, the upper arm S1 couples the axle 107 to the side member 101.

The control arm S2 constitutes one of the suspension arms as illustrated in FIGS. 3 to 6. Also, the control arm S2 is disposed below the suspension arm S in the vertical direction and on a straight line on which the first cross member 102 extends in a top view.

Holes are formed in the control arm S2 on the left side and the right side of the control arm S2. The control arm S2 is coupled to the axle 107 by a shaft being inserted into both the hole formed on the left side of the control arm S2 and the hole formed in the axle 107 and by a locking member, which is not illustrated, locking the shaft such that the shaft cannot fall off. Moreover, the control arm S2 is coupled to the first cross member 102 at a lower coupling portion 108L. At the lower coupling portion 108L, a shaft is inserted into both the hole formed on the right side of the upper arm S1 and the hole formed in the first cross member 102, which will be described later, and a locking member which is not illustrated, locks the shaft such that the shaft cannot fall off. In this manner, the control arm S2 couples the axle 107 to the first cross member 102.

The suspension arm bracket 106 is a member coupling the upper arm S1, the side member 101, and the first cross member 102 as illustrated in FIGS. 4 to 6. The suspension arm bracket 106 is formed by pressing a plate-shaped member made of metal such as iron, for example. As a coupling method, welding may be used, or a screw, a bolt, a nut, and the like may be used.

The suspension arm bracket 106 includes the upper coupling portion 108U, a side member attachment surface 109, and a first cross member attachment surface 112. The suspension arm bracket 106 couples the upper arm S1 and the side member 101 as described above at the upper coupling portion 108U. The suspension arm bracket 106 is attached to the side member attachment surface 109 and the first cross member attachment surface 112. In this manner, the side member 101 and the first cross member 102 are coupled.

The side member attachment surface 109 includes a second end portion attachment surface 110 and a body portion attachment surface 111. The suspension arm bracket 106 is attached to the second end portion 13 at the second end portion attachment surface 110. The suspension arm bracket 106 is attached to the body portion 11 at the body portion attachment surface 111.

Therefore, the subframe 100 according to an embodiment of the invention is the subframe 100 for holding a suspension device including: the pair of side members 101 extending in the front-back direction; the first cross member 102 coupling the side members 101 to connect the side members 101 in the vehicle width direction; a second cross member 103 disposed away from and behind the first cross member 102 and coupling the side members 101 to connect the side members 101 in the vehicle width direction; first vehicle body attachment points 104 disposed further backward than the first cross member 102 and formed to extend outward in the vehicle width direction from the side members 101; and second vehicle body attachment points 105 disposed further backward than the first vehicle body attachment points 104 and formed to extend outward in the vehicle width direction from the side members 101, and the suspension arms S extending form the suspension device are attached to the side members 101.

Moreover, in the subframe 100 according to the present embodiment, the suspension arms S may be disposed to be aligned on the straight line on which the first cross member 102 extends in a top view.

Furthermore, the subframe 100 according to the present embodiment may further include: the suspension arm brackets 106 for attaching the suspension arms S to the side members 101, the side members 101 may include the extended portions 10 extending further forward than the first cross member 102, and the suspension arm brackets 106 may be joined to parts of the side members 101 including the extended portions 10.

Additionally, in the subframe 100 according to the present embodiment, the extended portions 10 may extend in directions including direction components on the outer sides in the vehicle width direction, the extended portions 10 may include the second end portions 13 directed backward and extending in the up-down direction, and the suspension arm brackets 106 may be joined to the second end portions 13.

Furthermore, in the subframe 100 according to the present embodiment, the extended portions 10 may include the front end portions formed into the curved surface shapes.

As described above, according to the subframe 100 in the embodiment of the present invention, the first vehicle body attachment points 104 are disposed further backward than the first cross member 102 and are formed to extend outward in the vehicle width direction from the side members 101. Also, the second vehicle body attachment points 105 are disposed further backward than the first vehicle body attachment points 104 and are formed to extend outward in the vehicle width direction from the side members 101. In this manner, the distance between the first vehicle body attachment points 104 and the second vehicle body attachment points 105 is shorted, and it is possible to obtain compact side members 101, which contributes to weight reduction and enables reduction of manufacturing cost.

Furthermore, each of the first vehicle body attachment points 104 and the second vehicle body attachment points 105 is formed to extend outward in the vehicle width direction. Therefore, it is possible to maintain rigidity against a load in directions including components in the front-back direction and the vehicle width direction input from the suspension arms S to the subframe 100 without any loss even if the distance between the first vehicle body attachment points 104 and the second vehicle body attachment points 105 is shortened.

Moreover, according to the subframe 100 in the present embodiment, the suspension arms S are disposed to be aligned in the vicinity of the straight line on which the cross member extends. Therefore, it is possible to receive a load in directions including components in the front-back direction and the vehicle width direction input from the suspension arms S at a part with high rigidity.

Furthermore, according to the subframe 100 in the present embodiment, the side members 101 include the extended portions 10 extending further forward than the first cross member 102. Also, the suspension arm brackets 106 are joined to parts of the side members 101 including the extended portions 10. Therefore, attachment rigidity of the suspension arm brackets 106 and the side members 101 is improved.

Moreover, according to the subframe 100 in the present embodiment, the extended portions 10 extend in the directions including the direction components on the outer sides in the vehicle width direction, the extended portions 10 include the second end portions 13 directed backward and extending in the up-down direction, and the suspension arm brackets 106 are joined to the second end portion 13. Therefore, it is possible to efficiently disperse a load including a component in the front-back direction input from the suspension arms S to the extended portions 10 through the suspension arm bracket 106, and attachment rigidity of the suspension arms S and the suspension arm brackets 106 to the subframe 100 is improved as compared with a case in which the suspension arm brackets 106 are joined only to the body portion 11.

Moreover, according to the subframe 100 in the present embodiment, the extended portions 10 include the front end portions formed in to the curved surface shapes. Therefore, even if a car with the subframe 100 with the aforementioned configuration mounted therein is in a collision due to a traffic accident or the like and physical contact between the extended portion 10 and peripheral portions occurs, for example, it is possible to reduce a degree of breakage of the peripheral components.

Note that the technical scope of the invention is not limited to the aforementioned embodiment and various modifications can be made without departing from the gist of the invention.

Additionally, it is possible to replace the components in the aforementioned embodiment with known components, and the aforementioned modification examples may be appropriately combined, without departing from the gist of the invention.

What is claimed is:

1. A subframe that holds a suspension device, comprising:
a pair of side members extending in a front-back direction;
a first cross member coupling the side members to connect the side members in a vehicle width direction;
a second cross member disposed away from and behind the first cross member and coupling the side members to connect the side members in the vehicle width direction;
a first vehicle body attachment point disposed further backward than the first cross member and formed to extend outward in the vehicle width direction from the side member; and
a second vehicle body attachment point disposed further backward than the first vehicle body attachment point and formed to extend outward in the vehicle width direction from the side member,
wherein a suspension arm extending from the suspension device is attached to the side member.

2. The subframe according to claim 1,
wherein the suspension arm is disposed to be aligned on a straight line on which the first cross member extends in a top view.

3. The subframe according to claim 1, comprising:
a suspension arm bracket for attaching the suspension arm to the side member,
wherein the side member includes an extended portion extending further forward than the first cross member, and
the suspension arm bracket is joined to a part of the side member including the extended portion.

4. The subframe according to claim 3,
wherein the extended portion extends in a direction including an outward direction component in the vehicle width direction,
the extended portion includes a second end portion directed backward and extending in an up-down direction, and
the suspension arm bracket is joined to the second end portion.

5. The subframe according to claim 3,
wherein the extended portion includes a front end portion formed into a curved surface shape.
